(19) United States
(12) Patent Application Publication
(10) Pub. No.: US 2006/0160049 A1
(43) Pub. Date: Jul. 20, 2006

(54) Flight simulator panel with active graphic display instrumentation

(76) Inventor: Faiek Zora, Odessa, FL (US)

Correspondence Address: Law Offices of Royal W. Craig, Suite 153, 10 N. Calvert Street, Baltimore, MD, 21202, US

(21) Appl. No.: 11/332,730

(22) Filed: Jan. 13, 2006

Related U.S. Application Data
(60) Provisional application No. 60/644,087, filed on Jan. 14, 2005.

(51) Int. Cl. G09B 9/02

(52) U.S. Cl. 434/29; 434/30

(57) ABSTRACT

A more realistic flight simulator that includes at least one projected electronic active graphic display of an aircraft instrument by means of an LCD projector device, and a rear projection screen material contained within an overlaying bezel which defines the perimeter of the subject simulated aircraft instrument face. The simulated display is controlled by a rotary control inclusive of a rotary switch, a mechanical static fiction device, a mechanical linking shaft and a knob, all mounted to the instrument panel at the bezel. The friction device provides the tactile force feel feedback of the instrument control indicative of the actual aircraft instrument being simulated. The electronic output from the rotary switch is connected to flight training device or flight simulator host computer by electronic input/output circuitry that is utilized to selectively vary the electronic active graphic display of the instrument face through the software graphic driver to the LCD projector.

### CROSS-REFERENCE TO RELATED APPLICATIONS

The present application derives priority from U.S. Provisional Application No. 60/644,087 filed: Jan. 14, 2005.

### BACKGROUND OF THE INVENTION

1. Field of the Invention

The present invention relates to flight simulator instrumentation and, more particularly, to a flight simulator panel that employs projected active graphic display instrumentation.

2. Description of the Background

The complexity, operating costs, and the operating environment of modem airplanes, together with the technological advances made in flight simulation, have encouraged the uses of simulated flight training devices and flight simulators for training and testing of flight crew members. The instrumentation in a modem airplane may be three dimensional, electromechanical analog aircraft instrumentation, or an electronic flight instrument system (EFIS) displayed on an LCD screen as an active graphic representation of the aircraft information, or a combination of both types. A variety of commercial and military flight training devices and flight simulators have been developed to simulate existing aircraft instrumentation, many comprising a full size replica of an airplane's instruments, equipment, panels and controls in a cockpit area, including assemblages of equipment and computer software programs necessary to represent the airplane in ground and flight conditions.

The Federal Aviation Administration (FAA) maintains extensive certification requirements for flight simulator systems, and in so doing differentiates among three frequently used simulation devices: 1) the flight simulator; 2) the flight training device (FTD); and 3) personal computer-based aviation training devices (PCATD). Each has very different capabilities and approved uses and, if approved, can be used to gain flight training hours by pilots. In 1980, the FAA published an Advanced Simulation Plan, which made the concept of total simulation an operational reality. This plan, contained in Federal Aviation Regulation (FAR) Part 121, describes criteria for flight simulators that can be used for different levels of training. As the training level increases, so to does the level of simulator fidelity required for certification. Under the FAR, a flight simulator “is a full-size aircraft cockpit replica of a specific type of aircraft, or make, model, and series of aircraft, includes the hardware and software necessary to represent the aircraft in ground operations and flight operations, uses a force cueing system that provides cues at least equivalent to those cues provided by a three-degree freedom of motion system, uses a visual system that provides at least a 45-degree horizontal field of view and a 30-degree vertical field of view simultaneously for each pilot, and has been evaluated, qualified, and approved by the Administrator.” The fidelity standards and approval criteria are very demanding, but if met a pilot's entire training and certification process can occur almost wholly on a properly approved simulator.

Prior to the early-1990's, simulator technology in the higher fidelity, regulatory agency qualified training devices and simulators used actual aircraft three-dimensional analog instruments, simulated three-dimensional analog instruments, or actual aircraft electronic flight information (EFIS) instruments. Unfortunately, actual aircraft instruments and simulated aircraft instruments are quite expensive. However, as computer generated graphic display technology improved and the cost of such technology decreased, it became more cost effective to seek methods for the utilization of electronic active graphic displays of three dimensional, analog instruments. In the recent past, this has been accomplished by displaying the active graphic images using a cathode ray tube (CRT) or liquid crystal display (LCD) screen.

For example, U.S. Pat. No. 5,490,783 to Stephens et al. issued Feb. 13, 1996 discloses a flight simulator having a simulated cockpit that includes a visual display screen for depicting a simulated cockpit viewpoint. A simulated instrument panel is provided which includes a CRT display device and an overlying bezel that defines the perimeter of an instrument face. A rotary switch with rotary encoder is mounted within the bezel, and outputs from the rotary switch are coupled to electronic circuitry to allow a pilot to selectively vary the displayed instrument face within the cathode ray tube display device, providing a realistic representation of an actual flight instrument. Similar instrument panels have been developed that use LCD screens rather than CRT screens. Unfortunately, in both cases the proximity of the CRT/LCD screen to the instrument face bezel interferes with accurate placement and spatial orientation of the instrument controls. The CRT or LCD screen must be recessed and the covering bezel depth increased to allow sufficient room to mount the instrument control mechanism. The resulting pilot view of the simulated instrument panel, particularly in a “cross-cockpit” view, presented the pilot with a less than accurate recessed instrument face image. On the other hand, any adaptations to the control mechanism to accommodate the CRT/LCD tends to degrade the tactile feel of the instrument controls and detracts from realism. In the case of the above referenced patent, Stephens et al. describe a rotary encoder coupled to the simulator host computer via circa-1996 proprietary electronic circuitry and circa-1996 computational hardware and software. The illustrated configuration interposed an unrealistic response latency (sometimes referred to as transport delay), between the time the pilot rotates the rotary switch until the active graphic displayed image changes state. The computational latency, or transport delay is a summation of the inherent delay within the analog electronic circuitry coupled with processing speed of the computational hardware and software. An objective measure for instrument response latency, as defined under the FAR simulator evaluation standards, is less than 150 milliseconds. Any lengthier computational latency can manifest itself as an unrealistic stepping movement of the displayed image.

It would be far more advantageous to provide an instrument panel within a flight training device or flight simulator, which provides electronic active graphic display of an airplane instrument in form, function, and tactile feel of the instrument controls in a manner not heretofore accurately provided in the prior art, sufficient to meet FAR and the FAA regulatory agency requirements.

### SUMMARY OF THE INVENTION

Accordingly, it is an object of the present invention to provide an improved flight training device or flight simulator.

It is another object to provide an improved flight training device or flight simulator having electronic active graphic display of an aircraft instrument and instrument controls accurately representative in form, function, and tactile feel of the simulated aircraft and accurately spatially oriented as in the actual aircraft, in order to present the pilot with an accurate instrument face image even in a “cross-cockpit” view.

It is still another object to provide a flight training device or flight simulator having electronic active graphic display instrumentation capable of meeting regulatory agency qualification criteria including instrument response latency standards.

According to the above-described objects, the present invention provides an improved flight training device or flight simulator that includes at least one projected electronic active graphic display of an aircraft instrument. An aircraft cockpit area is provided which includes pilot instrument panels, pilot controls, pilot seats, and other equipment and panels accurately replicated and spatially oriented to the aircraft simulated. A simulated instrument panel is provided within the simulated aircraft cockpit. At least one of the simulated aircraft instruments contained within the simulated instrument panel is displayed as an electronic active graphic display by means of an LCD projector device, a rear projection screen material contained within an overlaying bezel which defines the perimeter of the subject simulated aircraft instrument face. A rotary electromechanical instrument control, comprising an encoder/potentiometer, a mechanical static friction device, a mechanical linking shaft and a knob, is mounted to the instrument panel, the bezel and the rear projection material in the spatially accurate position for the instrument being simulated. The rotary electronic control provides an electronic output indicative of the direction of rotation and amount of rotation. The friction device provides the tactile force feel feedback of the instrument control indicative of the actual aircraft instrument being simulated. The electronic output from the rotary control is connected to flight training device or flight simulator host computer by electronic input/output circuitry which is utilized to selectively vary the electronic active graphic display of the instrument face through the software graphic driver to the LCD projector.

Additional objectives, features and advantages will be apparent in the written description which follows.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a pilot cross-cockpit view of the flight simulator training device 2 according to an embodiment the present invention, including a plurality of simulated instruments 6.

FIG. 2 is a front view of two simulated instruments 6 as in FIG. 1.

FIG. 3 is a system diagram of a preferred embodiment of the flight simulator training device 2 according to the present invention.

FIG. 4 is a side perspective view of an exemplary simulated instrument 6.

FIG. 5 is a front view of the bezel 22 which is a circular frame defining the perimeter of an instrument face, and a flange 23 for mounting to the dash.

FIG. 6 is a side view of an exemplary simulated instrument panel 6 as in FIG. 2.

FIG. 7 is a side exploded view of the instrument panel 6 as in FIG. 6.

FIGS. 8-11 are a perspective view, front view, side cross-section, and top view, respectively, of the forward friction base 151 of rotary control 18.

FIGS. 12-15 are a perspective view, front view, side view, and top cross-section view, respectively, of the rear friction base 161 of rotary control 18.

FIG. 16 is a composite of a front view (A), side cross-section (B), and installation view (C) of the mechanical static friction device 58 to bezel 22, collectively showing the assembly and exemplary dimensions of the entire rotary control 18 of FIGS. 5-7.

### DETAILED DESCRIPTION OF THE PREFERRED EMBODIMENT

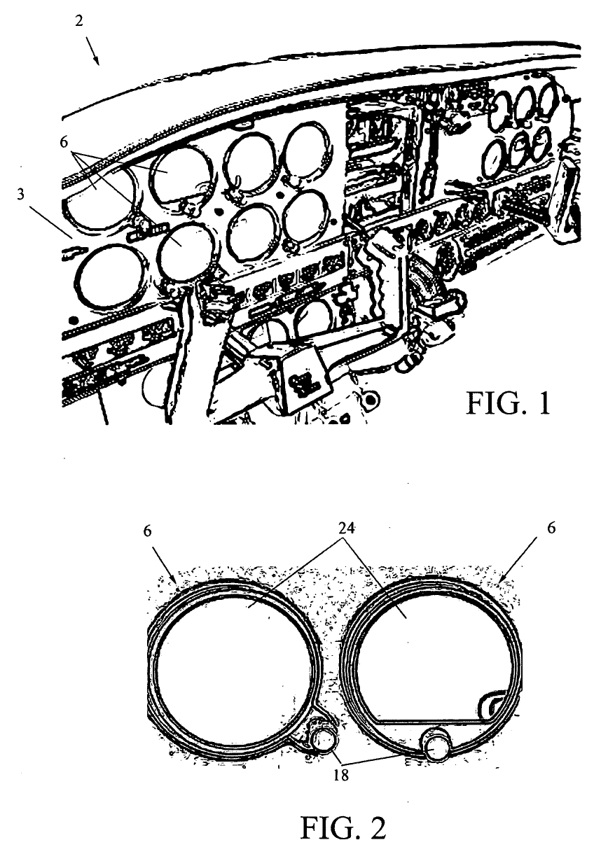

FIG. 1 is a perspective cross-cockpit view of a flight simulator training device 2 (flight simulator) according to one embodiment of the present invention. The flight simulator 2 includes an instrument console 3 including a plurality of simulated instruments 6 mounted behind a dash.

FIG. 2 is a front view of two simulated instruments 6 as in FIG. 1. Each simulated instrument 6 includes an electronic active graphic display 24 representing an actual aircraft instrument. Each simulated instrument 16 also includes a rotary electromechanical instrument control device 18, including a knob associated with the active graphic display 24, the knob of control device 18 being constrained by a mechanical static-friction coupling (as will be described) to impart a realistic frictional feel. In a preferred embodiment the aircraft cockpit area includes a full complement of simulated instruments 6, as well as other pilot instrument panels, pilot controls, pilot seats, and other equipment and panels as shown to accurately replicate the interior of a particular aircraft being simulated.

As described in greater detail below, utilization of projected imagery for the active graphic displays 14 of instruments 6 provides sufficient room to mount the rotary electromechanical instrument control 18 with its mechanical static friction device without the need to recess the image displays or increase the depth of the instrument bezel beyond that of the actual replicated aircraft. This greatly improves realism.

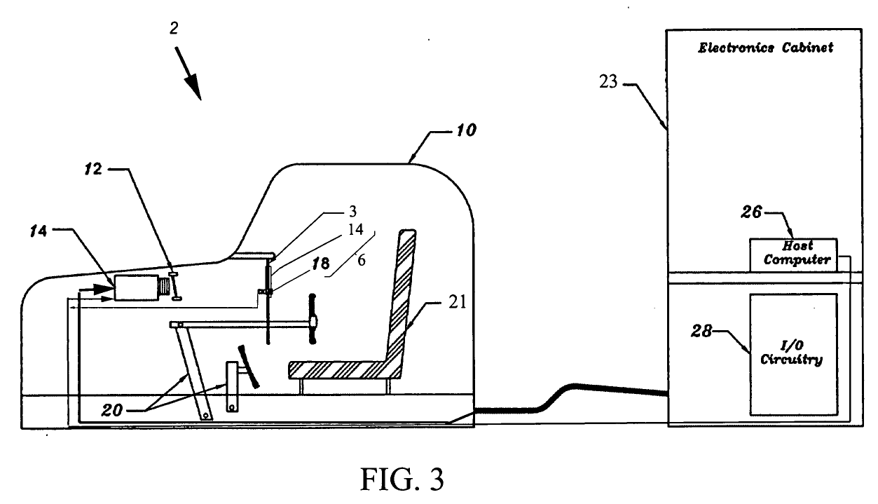

FIG. 3 is a system diagram of a preferred embodiment of the flight simulator training device 2 according to the present invention. The flight simulator training device 2 includes a cockpit area including simulated instrument console 3 including a plurality of simulated instruments 6 mounted behind a dash. Each simulated instrument 6 further comprises an electronic active graphic display 24 with rotary electromechanical instrument control device 18. The flight simulator training device 2 includes pilot flight controls 20, pilot seat 21, and related aircraft cockpit equipment. As will be described, each simulated instrument 6 is displayed onto the electronic active graphic display 24 by means of an LCD projector 14, using a rear projection approach to simulate one or more aircraft instrument faces, each framed by a bezel 22. The LCD projector may be any suitable LCD projector such as the Hitachi 49-02530-63859-2. In each case, a rotary instrument control 18 is mounted to a corresponding bezel 22, and the bezel 22 to the instrument panel 16. Any number of instruments may be simulated in this manner, all projected by a common LCD projector 14 onto panel 16 into separate bezels 22, each bezel 22 having its own rotary electromechanical instrument control 18.

Each rotary electromechanical instrument control 18 has an electronic analog output connected to a simulator host computer 26 through input/output (I/O) host circuitry 28 as an analog input (A/I) signal (inside electronics cabinet 23), and serves to electronically indicate the direction of rotation and amount of rotation. The simulator host computer 26 generates a digital graphic display image that is transmitted directly to an LCD projector 14 as a video output signal, which in turn projects the image through an optical beam-splitter 12 onto a rear projection material mounted behind the simulated instrument panel 16. The flight simulator graphic display hardware and driver are contained within the Host Computer 26, which is contained within the electronic cabinet 23, with interconnecting video cables running to the flight simulator cockpit. The display output from host computer 26 does not go through the host I/O circuitry 28, but is instead connected directly to projector 14 using a standard video cable running from an on-board PC graphics card to the projector 14. In the present system only the encoder 56 (to be described) of control knob 18 is connected the I/O circuitry 28.

The simulator host computer 26 may be any commercial computer or other computational hardware and software with robust graphics capabilities, for example, having memory, peripheral chipset, video driver such as the Inno 3D Tornado GeForge 5700LE-8X, and processor running an operating system such as Linux™, Windows 2000™, XP™, or the like. The host computer 26 also relies on a conventional video simulation software package for compiling an interactive instrument simulation sequence that is transmitted through the standard video cable to the projector.

As stated above, it is important to minimize the computational latency, or “transport delay”, which is a summation of the inherent delay within the electronic circuitry coupled with processing speed of the computational hardware and software. An objective measure for instrument response latency, as defined under the Federal Acquisition Regulations FAR simulator evaluation standards for Level 7 devices is less than 150 milliseconds. To accomplish this, the present system should employ commercially-available electronic I/O, computational hardware and software, graphics driver and LCD projector that responds and performs the simulation-feedback-display functions at a minimum 60 Hz cycle rate, as this results in a measured transport delay of less than 150 milliseconds. Depending on the complexity of the flight training simulator there may be additional computers (in addition to simulator host computer 26) for controlling other functions or for overall control. In such case all computers including simulator host computer 26) may be networked together utilizing conventional network LAN technology, using ethernet connections and TCP/IP communication, and serial cables for other controls. These would all be in place for the total simulation regardless of the new simulated instrument technology disclosed herein.

A beam splitter 12 is used to attenuate the image projected from LCD Projector 14, and this may be any suitable beam splitter/attenuator such as the Edmond Industrial Optics NT31-432 which is a variable reflectivity aluminum mirror for use in optical beam splitting or attenuator applications. The beam splitter 12 is pivotally mounted in advance of the projector. Thus, an incident light beam directed onto the reflector substrate of the beam splitter 12 is split into two components: a reflected and transmitted beam. Only the transmitted beam is propagated through to the projection material 24. Any relative intensity ratio between the two beams may be selected by pivoting/rotating the mirror to the proper radial location. This feature is used to selectively dim the displayed LCD graphic image: a significant improvement inasmuch as a projected LCD image or CRT or any other flat two dimensional image appears brighter than an actual three dimensional instrument being simulated. In the present implementation of a high resolution LCD projector 14 with optical beam splitter 12 to attenuate the high-resolution image, the displayed instrument more accurately replicates the appearance of an actual aircraft instrument.

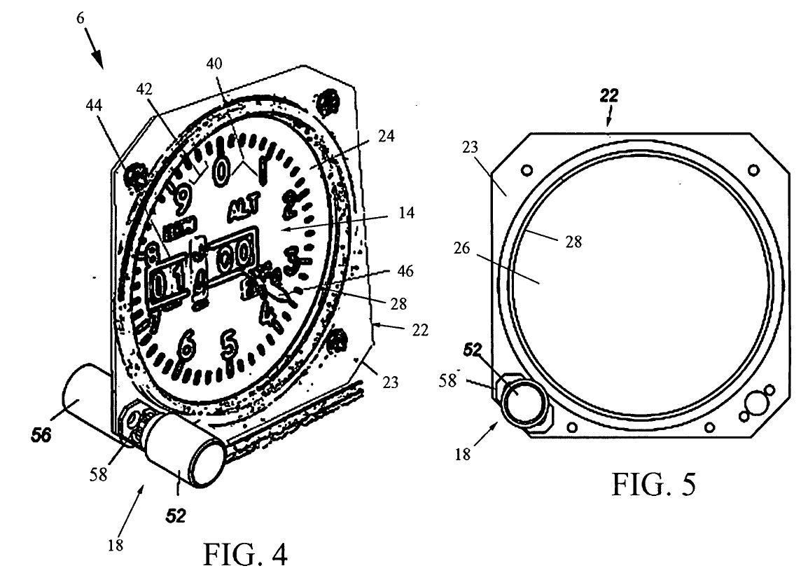

FIG. 4 is a side perspective view of an exemplary simulated instrument 6 from the console of FIGS. 1-2. Each simulated aircraft instrument 6 residing on the console is replicated by means of an active graphic display 24 framed by a metal bezel 22 which is mechanically mounted or integrally formed in a spatially accurate position for mounting to the dash.

FIG. 5 is a front view of the bezel 22 which is a circular frame defining the perimeter of an instrument face, and a flange 23 for mounting to the dash. The frame of bezel 22 is defined by a substantially circular aperture 26 bounded by a collar 28 for seating and securing a circular shaped section of rear projection material 24, and integral flange 23 for mounting to the dash. The rear projection material may be any suitable rear projection material such as the Draper Cineplex ¼″ thick acrylic. The bezel 22 also provides a mounting for the rotary electromechanical instrument control 18, and the flange 23 is machined at the corners to receive the rotary instrument control 18 on either side, here shown at lower left. The collar 28 of bezel 22 supports the rear projection material 24 substantially flush with the plane of the dash panel 23, which improves fidelity. The fidelity of the present invention is also improved by more measurably accurate tactile force feel. For this purpose, the rotary electromechanical instrument control 18 includes a mechanical static friction device for providing accurate tactile force feel, feedback to the pilot's manual rotation of the knob (as will be described).

Referring back to FIG. 4, the LCD projector 14 is mounted behind the rear projection material 24 and casts a projected image thereon. In the illustrated FIG. 4, the projected image comprises a simulated altimeter instrument including a radially-oriented gradient scale 42 with 1000 ft. scale 40 and needle-indicator 46, plus a complementary digital readout 44. The rotary control 18 is situated at bottom-left. In use, a pilot varies the simulated instrument display components by rotating the knob 52 of rotary control 18. Electrical outputs from the rotary instrument control 18 are connected to the flight simulator host computer 26 by standard electronic input/output (I/O) circuitry. The host computer 26 utilizes the inputs from the rotary control 18 to calculate the instrument display component changes and then to selectively vary the electronic active graphic display image of the instrument face through the software graphic driver to the LCD projector 14. The use of rear projection material 24 allows a simulated instrument control with correct spatial orientation mounting position as a replica of the actual aircraft. The rear projection screen material is a transparent substrate acrylic, within a permanently bonded optical coating. This coating is an emulsion of microscopic particles, which function as refractive lenses. It diffuses and distributes projected light, reproducing the projected image. A variety of Acrylic rear projection screens are currently manufactured and can be special ordered in an array of circular sizes and thicknesses depending on the aircraft being simulated.

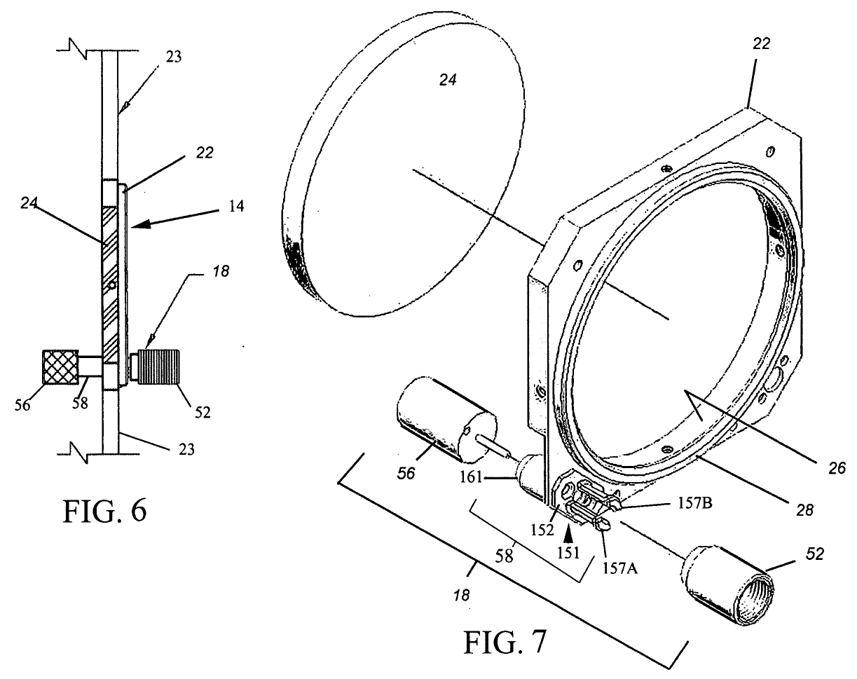

FIGS. 6 and 7 collectively also show the rotary control 18 inclusive of control knob 52 for manual rotation, and mechanical static friction device 58 secured (or integrally attached) to the flange 23 of bezel 22 for imparting a selectable degree of turning-resistance to knob 52. In addition, an encoder or potentiometer 56 is mounted behind the bezel 22 for transmitting digital feedback to the host computer 26. The control knob 52 is a conventional machined aluminum rotary knob machined and textured to appear as an actual aircraft knob.

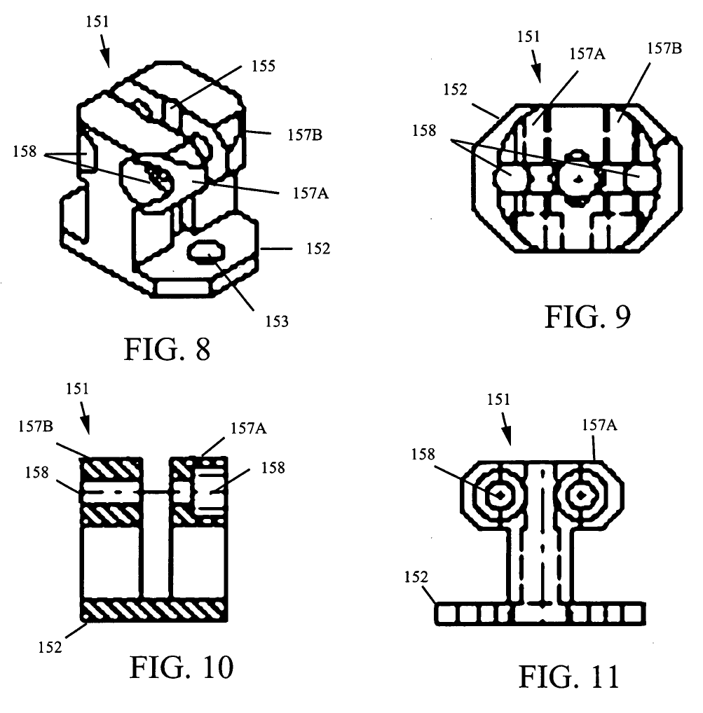

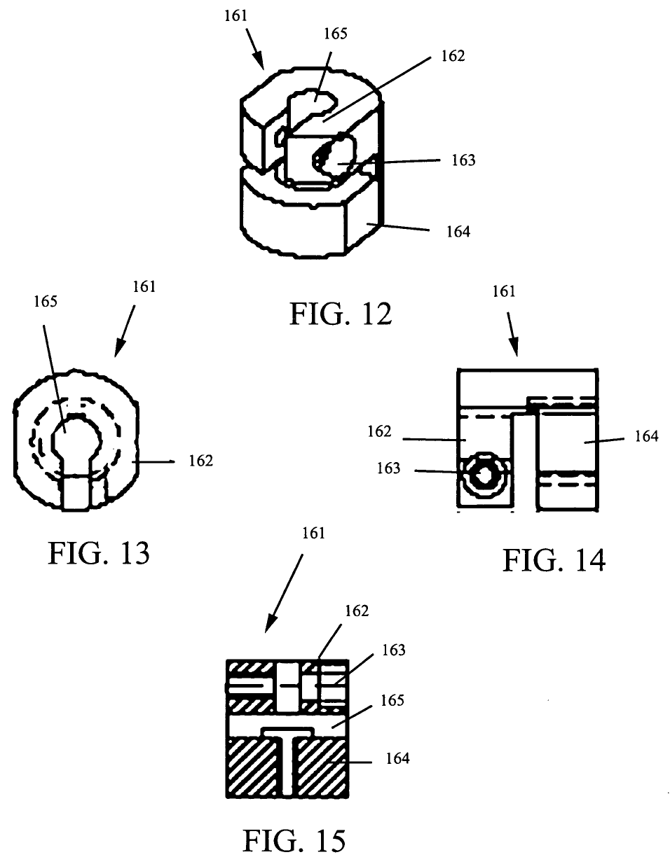

FIGS. 8-15 collectively detail the two primary components of the mechanical static friction device 58, which include a forward friction base 151 (FIGS. 8-11) mounted in advance of bezel 22 and a rear friction base 161 (FIGS. 12-15) mounted behind bezel 22.

As seen in FIGS. 8-11, the forward friction base 151 comprises a mounting flange 152 with opposing through-holes 153 for mounting to the flange 23 of bezel 22. Opposing spring fingers 157A & 157B protrude forwardly from the flange 152, spaced slightly apart, and both spring fingers 157A & 157B are defined by inward semi-cylindrical grooves 155 which conform to the shaft of the encoder/potentiometer 56 mounted behind. The spring fingers 157A & 157B flare outward and are defined by screw-holes 158 for receiving compression screws threaded into the opposing spring finger. The compression screws can be selectively tightened or loosened to impart a varying degree of friction against the encoder/potentiometer 56 shaft (upon which knob 52 is mounted), thereby providing adjustment capability for an accurate tactile force feel feedback to the pilot's manual rotation of the knob 52. The entire forward friction base 151 may be integrally molded of Delrin™ plastic or the like.

As seen in FIGS. 12-15, the rear friction base 161 comprises an annular collar with a open-compressible-yoke section 162 defined by a through-bore 163 for receiving a compression screw for imparting and adjustable degree of compression to the yoke 162. The yoke section 162 is joined to a base 164 which abuts the encoder/potentiometer 56 (the yoke section 162 abutting the rear of the flange 23 of bezel 22. The entire rear friction base 161 is defined by a cylindrical through-bore 165 running lengthwise through both the yoke 162 and base 164 for passing the encoder/potentiometer shaft and, as above, the compression screw can be selectively tightened or loosened to impart a varying degree of friction against the encoder/potentiometer 56 shaft (upon which knob 52 is mounted), thereby providing adjustment capability for an accurate tactile force feel feedback to the pilot's manual rotation of the knob 52. The entire rear friction base 161 may likewise be integrally molded of Delrin™ plastic or the like.

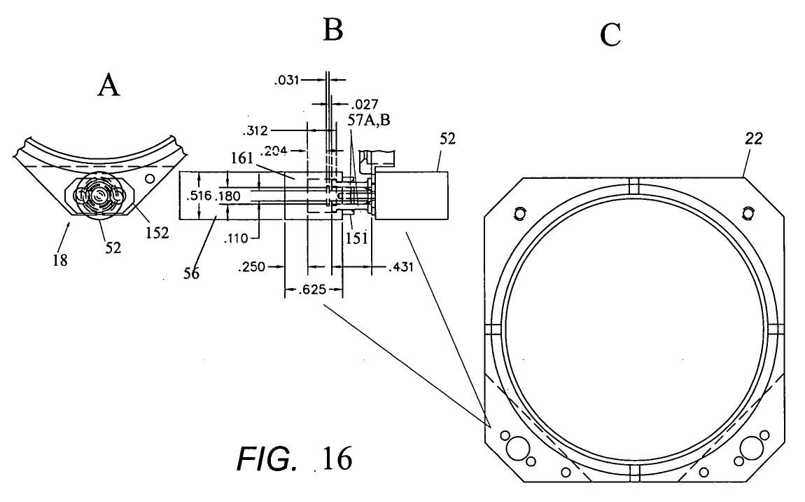

FIG. 16 is a composite of a front view (A), side cross-section (B), and installation view (C) of the mechanical static friction device 58 to bezel 22, collectively showing the assembly and exemplary dimensions of the entire rotary control 18 of FIGS. 5-7, inclusive of control knob 52, the rear friction base 161, and the forward friction base 151. The rear friction base 161 is sandwiched between the encoder/potentiometer 56 and the rear of the flange 23 of bezel 22, and the encoder/potentiometer 56 shaft passes through the rear friction base 161 and the bezel 22 into the forward friction base 151. The forward friction base 151 is mounted via flange 152 to the fore of bezel 22 and opposing spring fingers 157A & 157B are clamped around the shaft of the encoder/potentiometer 56 passing there through. The knob 52 is mounted on the end of the encoder/potentiometer 56 shaft. With this configuration, both the rear and forward friction bases 151, 161 can be adjusted to preset the friction encountered by the pilot when turning knob 52, thereby providing a more accurate tactile-force feel to the pilot's manual rotation of the knob 52.

The friction device 58 (inclusive of 151, 161) effectively becomes an adjustable clamp around the potentiometer shaft. The friction on the shaft is then tuned by individually adjusting the screws until the knob rotation tactile feel is similar to that of the actual aircraft instrument being simulated.

The encoder/potentiometer 56 is used to generate an electronic analog signal equivalent to the direction and amount of knob rotation, and may be any suitable encoder such as the CUI, Inc. 070-0149, or any suitable potentiometer such as the Honeywell 392JA50K (available from Peerless Components, Inc.) or the Sakae 10HP-10-10K-H (available from Feteris Components) multi-turn potentiometer. It is noteworthy that potentiometers have limited turning capability, and so an encoder is generally a more suitable component 56 when continual 360 degree knob rotation is desired.

It should now be apparent that the above-described flight simulator 2 with instrument console 3 incorporating one or more simulated instruments 6 based on rear-projection active graphic LCD display more accurately represents in form, function, and tactile feel the simulated aircraft, and accurately presents the pilot with a detailed face image even in a “cross-cockpit” view. This meets or exceeds all existing regulatory agency qualification criteria including instrument response latency standards.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth herein.

We claim:

1. A simulator comprising:
an instrument panel comprising a dash;
at least one simulated instrument on said instrument panel for providing a visual output simulative of an instrument face to a pilot seated on one side thereof, said simulated instrument further comprising,
a bezel mounted on said instrument panel and formed with an aperture for defining a perimeter of said at least one simulated instrument, and
a section of rear projection screen material mounted in the aperture of said bezel substantially flush to said dash;
a projector mounted on another side of said instrument panel for projecting said visual output simulative of the instrument face; and
a host computer connected to said projector for generating said visual output.

2. The simulator according to claim 1, further comprising a rotary control mounted on said bezel and connected to said host computer for allowing said pilot to manually vary said simulated instrument face.

3. The simulator according to claim 1, wherein said projector is an LCD projector.

4. The simulator according to claim 3, further comprising an optical beam-splitter mounted between said section of rear projection screen material and said LCD projector for attenuating a projected image from said projector.

5. The simulator according to claim 2, wherein said rotary control further comprises a control knob mounted in advance of said bezel on a common shaft with one of an encoder or potentiometer mounted behind the bezel and connected to said host computer for varying said projected instrument face when said pilot turns said control knob.

6. The simulator according to claim 5, further comprising a mechanical static friction device engaging said common shaft for imparting a degree of friction thereto to provide a tactile force countering a pilot's manual rotation of the control knob.

7. The simulator according to claim 6, wherein said mechanical static friction device is adjustable to allow presetting of said degree of friction.

8. A simulator comprising:
an instrument panel comprising a dash;
at least one simulated instrument on said instrument panel for providing a visual output simulative of an instrument face to a pilot seated on one side thereof, said simulated instrument further comprising,
a bezel mounted on said instrument panel and formed with an aperture for defining a perimeter of said at least one simulated instrument, and
a section of rear projection screen material mounted in the aperture of said bezel substantially flush to said dash;
a projector mounted on another side of said instrument panel for projecting said visual output simulative of the instrument face, said projector being coupled to a host computer; and
a rotary control mounted on said bezel and connected to said host computer for allowing said pilot to manually vary said simulated instrument face.

9. The simulator according to claim 8, wherein said rotary control mounted on said bezel is connected to said host computer for allowing said pilot to vary said simulated instrument face.

10. The simulator according to claim 9, wherein said projector is an LCD projector.

11. The simulator according to claim 10, further comprising an optical beam-splitter mounted between said section of rear projection screen material and said LCD projector for attenuating a projected image from said projector.

12. The simulator according to claim 9, wherein said rotary control further comprises a control knob mounted in advance of said bezel and operatively coupled to one of an encoder or potentiometer mounted behind the bezel and connected to said host computer for varying said projected instrument face when said pilot turns said control knob.

13. The simulator according to claim 8, wherein said rear projection screen material comprises a transparent substrate acrylic having a permanently bonded refractive optical coating.

14. The simulator according to claim 11, wherein said beam splitter comprises a pivotally-mounted variable reflectivity aluminum mirror for splitting an incident light beam from said projector into two components including a reflected and transmitted beam, only the transmitted beam being projected onto said projection screen material, whereby a relative intensity ratio between the reflected and transmitted beams may be adjusted by pivoting the beam splitter.

15. The simulator according to claim 12, wherein said control knob is on a common shaft with said encoder or potentiometer.

16. The simulator according to claim 15, further comprising a mechanical static friction device engaging said common shaft for imparting a degree of friction thereto to provide a tactile force countering a pilot's manual rotation of the control knob.

17. The simulator according to claim 16, wherein said mechanical static friction device is adjustable to allow presetting of said degree of friction.
